(19) United States
(12) Patent Application Publication
(10) Pub. No.: US 2004/0063361 A1
(43) Pub. Date: Apr. 1, 2004

(54) Terminals

(76) Inventor: Stephen Hampson, Springhead, Oldham (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/332,623

(22) PCT Filed: Jul. 11, 2001
(86) PCT No.: PCT/EP01/08015

(30) Foreign Application Priority Data
Jul. 12, 2000 (GB) 0017002.7

(51) Int. Cl. H01R 4/10

(52) U.S. Cl. 439/882

(57) ABSTRACT

Described herein is a simplified electrical connection terminal (60) which comprises two folded terminal portions (62, 64) connected together by a plate portion (74). The terminal (60) is made from a single piece of material which can be pressed and folded to shape in a single manufacturing process.

### FIELD OF INVENTION

The present invention relates to improvements in or relating to terminals, and is more particularly, although not exclusively concerned with terminals for electricity meters.

### BACKGROUND TO THE INVENTION

In electricity meters, it is known to connect the neutral line from an incoming supply, for example, from an electricity supplier, to the neutral line of a consumer's supply. Such a connection is conventionally achieved by linking two electrical terminals together by means of a connecting plate. However, such arrangements are made of several components, which are made individually and then joined together at a later stage.

### OBJECT OF THE INVENTION

It is therefore an object of the present invention to provide an electrical connection terminal, which is manufactured from a single piece of material in a single manufacturing process.

### STATEMENT OF INVENTION

In accordance with a first aspect of the invention, there is provided a terminal arrangement comprising first and second terminal portions having a tubular construction for receiving electrical cables, the arrangement being formed from a single piece of folded sheet material. Conveniently, the sheet material comprises an elongate strip of metal folded to form said first and second terminal portions

The first and second terminal portions can be substantially parallel to each other, and can be spaced apart.

The first and second terminal portions are separated by a plate portion, to which another connection can be made. Said first and second terminal portions can have a substantially square cross section.

The terminal arrangement can conveniently be employed in an electricity meter.

### BRIEF DESCRIPTION OF THE FIGURES

The invention may be understood more readily, and various other aspects and features of the invention may become apparent from consideration of the following description and the figures as shown in the accompanying drawing sheets, wherein:

FIGS. 1 to 5 illustrate known linked terminals;

FIGS. 6 and 7 illustrate an electrical connection terminal in accordance with the present invention; and

FIGS. 8 to 10 illustrate variations of the electrical connection terminal shown in FIGS. 6 and 7.

### DETAILED DESCRIPTION OF THE INVENTION

There will now be described, by way of example, the best mode contemplated by the inventors for carrying out the invention. In the following description, numerous specific details are set out in order to provide a complete understanding of the present invention. It will be apparent, however, to those skilled in the art, that the present invention may be put into practice with variations of this specific.

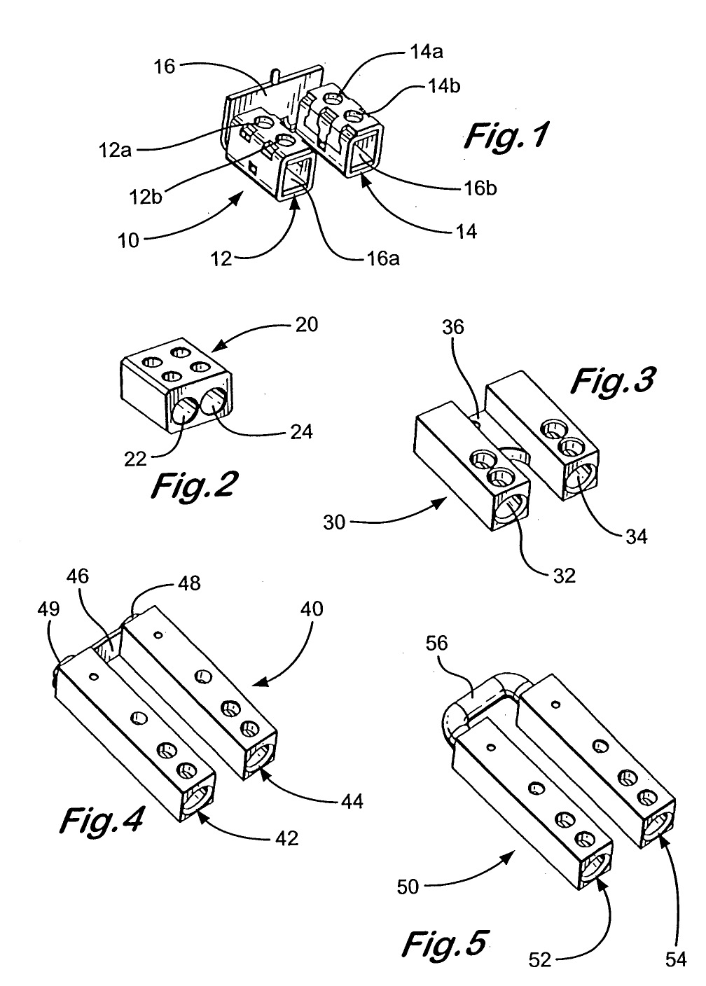

Referring initially to FIG. 1, a linked terminal arrangement 10 is shown comprising two terminals 12, 14 and a linking strip 16. Each terminal 12, 14 is formed by pressing and folding a single piece of metal to form a generally tubular construction having a substantially square cross section. The linking strip is formed from another piece of metal which is connected to one end of each terminal 12, 14 by welding, soldering or brazing. Alternatively, the linking strip 16 may include tangs 16a, 16b which extend into the terminals 12, 14 and against which a cable (not shown) is compressed using pinch screws (also not shown) which are inserted into holes 12a, 12b, 14a, 14b. This arrangement 10 requires three components.

FIG. 2 shows an extruded terminal arrangement 20 which is extruded as a single piece and then machined. The arrangement has two apertures 22, 24 which are adjacent to one another. The two apertures 22, 24 can be electrically connected together if the arrangement is extruded from an electrically conductive material, for example, brass etc.

Another extruded terminal arrangement 30 is shown in FIG. 3. The arrangement is extruded and machined to provide the shape shown. The arrangement comprises two terminal blocks 32, 34 which are joined together by a linking plate 36. Again, the electrical connection is provided if the arrangement is extruded from an electrically conductive material.

In FIG. 4, a terminal arrangement 40 is shown which comprises two extruded terminal blocks 42, 44 which are joined together by a pressed linking strip 46. The linking strip 46 is connected to one end of each terminal block 42, 44 by means of rivets 48, 49. In this case, five components are required.

FIG. 5 illustrates a terminal arrangement 50 which is similar to that shown in FIG. 4 but with only three components. Again, two extruded terminal blocks 52, 54 are utilised which are joined together by a folded link 56 as shown, the link 56 being joined to the terminal blocks 52, 54 by welding, soldering, brazing, or impact riveting.

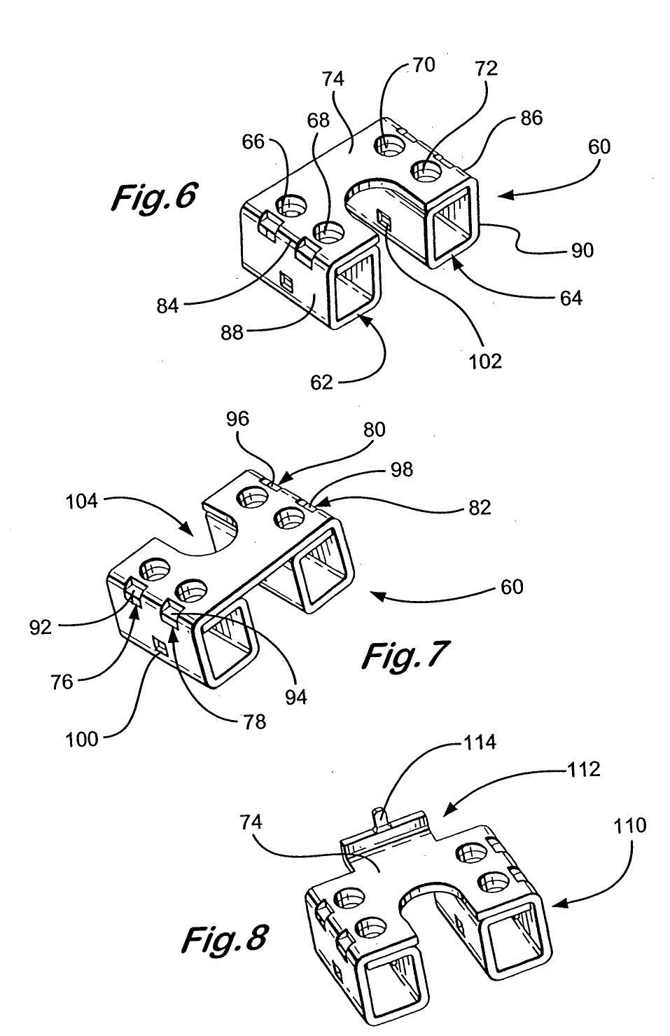

In accordance with the present invention, terminal arrangement 60 as shown in FIGS. 6 and 7 is manufactured from a single piece of material using a single manufacturing process.

Terminal arrangement 60 comprises two folded terminal portions 62, 64 each having two apertures 66, 68, 70, 72 through which screws (not shown) can be inserted for securing a cable in a respective one of the folded terminal portions 62, 64. As shown, the folded terminal 62, 64 are generally tubular having a substantially square cross section and are connected together by means of a plate portion 74.

The terminal arrangement 60 is made from a thin elongate strip of material, for example, brass or other similar material, which is pressed to provide apertures 62, 64, 66, 68 and apertures 76, 78, 80, 82 which lie on respective bends 84, 86 which define where outer side walls 88, 90 of each folded terminal portion 62, 64 meet the plate portion 74. Apertures 76, 78, 80, 82 provide location points for tab portions 92, 94, 96, 98 formed at each end of strip of material to keep the folded terminal portions 62, 64 in place. Other apertures or cut-outs 100, 102, 104 may be formed in the terminal arrangement to locate tangs and or to clear adjacent parts in an assembly in which the arrangement is to be used.

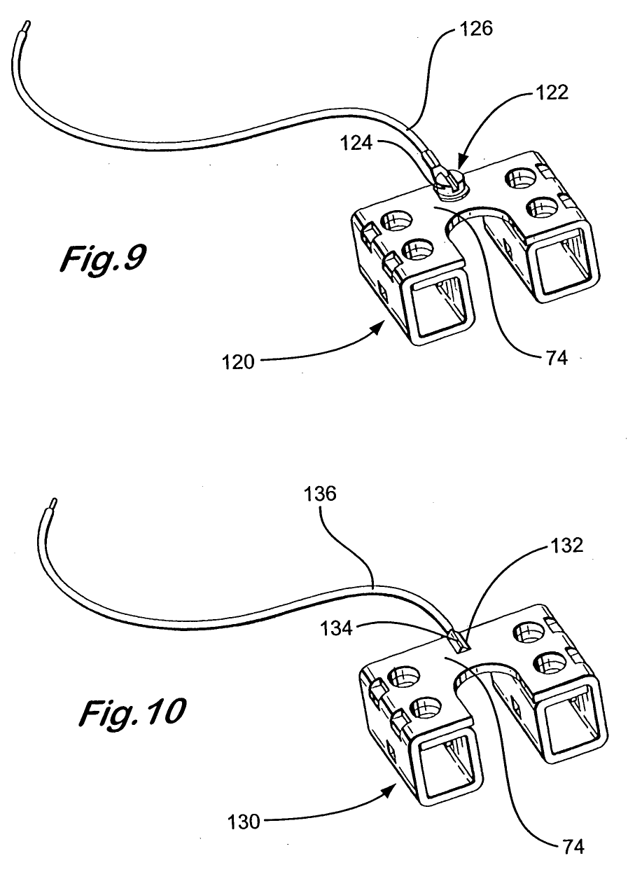

As shown in terminal arrangements 110, 120, 130 of FIGS. 8 to 10, the plate portion 74 may be modified to provide a further terminal connection, for example, an internal connection.

In FIG. 8, the plate portion 74 of the terminal arrangement 110 is extended and folded upwards to form a lip 112 having a tab 114 to which an electrical connection can be made, for example, by crimping, soldering or brazing.

In FIG. 9, the plate portion 74 has a hole 122 formed therein to accept a screw 124 to attach a cable 126 to the terminal arrangement 120.

In FIG. 10, the terminal arrangement 130 has a recess 132 formed in the plate portion 74 for receiving an end 134 of a cable 136. The end 134 may be soldered in the recess 132 to provide the desired electrical connection.

It will readily be appreciated that the terminal arrangement in accordance with the present invention may be used in any application where it is desired to link two terminals together. It is particularly useful in electricity meters where the incoming neutral line (from an electricity supply) is to be connected to the outgoing neutral line (to a consumer's supply).

Although the present invention has been described with reference to a terminal arrangement having a plate portion connecting the two terminal block portions, it will be appreciated that the plate portion may not essential and it may be possible that the two folded terminal portions may be adjacent one another and in direct contact.

1. A terminal arrangement (60) comprising first and second terminal portions (62,64) having a tubular construction for receiving electrical cables, the arrangement being formed from a single piece of sheet material.

2. A terminal arrangement according to claim 1, wherein the sheet material comprises an elongate strip of metal.

3. A terminal arrangement according to claim 1, wherein the first and second terminal portions are substantially parallel to each other.

4. A terminal arrangement according to claim 1 or 2, wherein the and second terminal portions are separated by a plate portion.

5. A terminal arrangement according to claim 3, wherein another connection can be made to said plate portion.

6. A terminal arrangement according to any one of the preceding claims, wherein the first and second terminal portions have a substantially square cross-section.

7. A terminal arrangement according to any one of the proceeding claims, comprising apertures or cut-outs operable to locate tangs and or clear adjustments parts in an assembly in which the arrangement is to be used.

8. A terminal arrangement according to any one of the proceeding claims, mounted in an electricity meter.
